(19) United States
(12) Patent Application Publication
(10) Pub. No.: US 2024/0354621 A1
(43) Pub. Date: Oct. 24, 2024

(54) QUANTUM PROGRAM COMPILATION METHOD AND QUANTUM PROGRAM COMPILATION APPARATUS

(71) Applicant: Hitachi, Ltd., Tokyo (JP)

(72) Inventors: Naoto SATO, Tokyo (JP); Takuro MORI, Tokyo (JP)

(21) Appl. No.: 18/376,696

(22) Filed: Oct. 4, 2023

(30) Foreign Application Priority Data
Oct. 28, 2022 (JP) 2022-173526

(51) Int. Cl. G06N 10/40

(52) U.S. Cl. CPC G06N 10/40

(57) ABSTRACT

A quantum program compilation apparatus stores, in a storage device, information regarding a node topology representing a connection relationship between nodes on which a quantum bit is formed and information regarding a control operation that can be performed in a predetermined region of the node topology, and generates, for a quantum program described by a combination of control operations on the quantum bit, a procedure of a movement operation on the quantum bit according to the connection relationship as a procedure of executing the control operation of the quantum program in a predetermined region in the node topology on the basis of each piece of information of the node topology and the control operation.

### CROSS-REFERENCE TO RELATED APPLICATION

The present application claims priority pursuant to 35 U.S.C. § 119 to Japanese Patent Application No. 2022-173526 filed on Oct. 28, 2022, the entire disclosure of which is hereby incorporated herein by reference.

### BACKGROUND OF THE INVENTION

### 1. Field of the Invention

The present invention relates to a quantum program compilation method and a quantum program compilation apparatus.

### 2. Description of the Related Art

In order to realize a quantum computer, it is necessary to implement a quantum bit capable of simultaneously superimposing and holding values of 0 and 1.

For example, in a silicon electronic quantum computer, a quantum bit is realized by confining electrons in a quantum dot implemented by a field effect transistor or the like.

A control operation (operation for computation) on the quantum bit is performed by applying a static magnetic field or an electromagnetic pulse to the quantum bit. However, it is difficult to generate a static magnetic field or an electromagnetic pulse only in a target quantum bit.

As primitive computation in a quantum computer, there are one-quantum-bit computation of operating one quantum bit and two-quantum-bit computation of causing interaction between two quantum bits. In order to realize the two-quantum-bit computation of the two types of computation, it is necessary to dispose two target quantum bits close to each other. Therefore, in order to be able to execute two-quantum-bit computation for more pairs, it is necessary to dispose quantum bits as close as possible to each other.

However, if the quantum bits are disposed too close to each other, when a control operation is performed on a certain quantum bit, interference also occurs in unrelated quantum bits around the quantum bit. As a result, there is a problem that a state of the quantum bits changes unexpectedly and a computation result with low fidelity is obtained.

In order to apply a static magnetic field or an electromagnetic pulse to a quantum bit, a control line for applying a voltage or a current to an electrode for controlling the quantum bit is required. In a case of a design in which control lines are individually disposed with respect to quantum bits, the number of control lines also increases with an increase in the number of quantum bits. Therefore, there is a problem that it is difficult to implement a large number of quantum bits due to a spatial restriction of disposing the control lines.

For this problem, as disclosed in JP 2021-27142 A, a method of simultaneously controlling a plurality of quantum bits with one control line is effective. In the method disclosed in JP 2021-27142 A, quantum bits are disposed in an array, and a common control line is provided in units of columns or rows. Computation on the quantum bits is realized by the control line.

However, since the control line is shared by the units of the same columns or rows as described above, when a control operation is performed on a certain quantum bit, the control operation is also performed on unrelated quantum bits in the same column or the same row. As a result, a computation result different from the expectation is obtained.

As described above, although there is a slight difference depending on implementation of a control line, when computation is executed on a certain quantum bit, the computation may also affect surrounding quantum bits and quantum bits in the same column or the same row. As a result, there is a problem that a computation result with low fidelity or a computation result different from expectation can be obtained.

As a technique for solving the above problem, a quantum bit movement operation can be utilized in a silicon electronic quantum computer.

The movement operation in the silicon electronic system is an operation of spatially moving electrons configuring a quantum bit to adjacent quantum dots (which are empty dots in which electrons are not disposed). This movement operation makes it possible to isolate unrelated quantum bits from a control target quantum bit, and thus may reduce unnecessary influence on the quantum bits.

### SUMMARY OF THE INVENTION

However, the movement operation is also realized by applying a voltage to an electrode. Thus, there may be a certain (side effect) influence on a target quantum bit and surrounding quantum bits. Therefore, it is necessary to appropriately design a movement operation in consideration of the influence of the control operation on a quantum bit and the influence of the movement operation. In addition, a quantum bit movement operation procedure depends on content of computation described as a quantum program. For example, the quantum bit movement operation procedure also depends on the number of quantum bits to be used, the type and number of quantum bit computations, or the execution order thereof.

As described above, in a case where a quantum program that is an execution target is given, it is necessary to design a movement operation procedure corresponding to the quantum program and input the movement operation procedure to a quantum computer. However, a method thereof is not obvious.

Since the design of the movement operation procedure is performed before the execution of the quantum program, if it takes time to design the movement operation procedure, the time after the quantum program is provided to the quantum computer until a computation result is obtained also increases. Thus, in practical use, it is required to complete the design of the movement operation procedure in a short time.

Therefore, an object of the present invention is to provide a technique through which a movement operation procedure corresponding to the content of a quantum program can be quickly determined.

In order to solve the above problem, according to the present invention, there is provided a quantum program compilation method including causing an information processing apparatus to: store, in a storage device, information regarding a node topology representing a connection relationship between nodes on which a quantum bit is formed and information regarding a control operation that can be performed in a predetermined region of the node topology; and generate, for a quantum program described by a combination of control operations on the quantum bit, a procedure of a movement operation on the quantum bit according to the connection relationship as a procedure of executing the control operation of the quantum program in a predetermined region in the node topology on the basis of each piece of information of the node topology and the control operation.

According to the present invention, there is provided a quantum program compilation apparatus including a storage device that stores information regarding a node topology representing a connection relationship between nodes on which a quantum bit is formed and information regarding a control operation that can be performed in a predetermined region of the node topology; and a computation device that generates, for a quantum program described by a combination of control operations on the quantum bit, a procedure of a movement operation on the quantum bit according to the connection relationship as a procedure of executing the control operation of the quantum program in a predetermined region in the node topology on the basis of each piece of information of the node topology and the control operation.

According to the present invention, it is possible to quickly determine a movement operation procedure corresponding to content of a quantum program.

### BRIEF DESCRIPTION OF THE DRAWINGS

FIG. 1 is a network configuration diagram including a quantum program compilation apparatus of an embodiment;

FIG. 2 is a diagram illustrating a hardware configuration example of the quantum program compilation apparatus according to the present embodiment;

FIG. 3 is a diagram illustrating an example of a quantum program according to the present embodiment;

FIG. 4 is a diagram illustrating a configuration example of node topology information according to the present embodiment;

FIG. 5 is a diagram illustrating an example of a quantum dot topology of the present embodiment;

FIG. 6 is a diagram illustrating an example of a region configuring the quantum dot topology of the present embodiment;

FIG. 7 is a diagram illustrating a configuration example of control operation information according to the present embodiment;

FIG. 8 is a diagram illustrating an example of an in-region operation method of the present embodiment;

FIG. 9 is a diagram illustrating an example of an in-region operation method of the present embodiment;

FIG. 10 is a diagram illustrating an example of an in-region operation method of the present embodiment;

FIG. 11 is a diagram illustrating an example of an in-region operation method of the present embodiment;

FIG. 12 is a flowchart of a quantum program compilation method of the present embodiment; and

FIG. 13 is a flowchart of a quantum program compilation method of the present embodiment.

### DESCRIPTION OF THE PREFERRED EMBODIMENTS

### Network Configuration

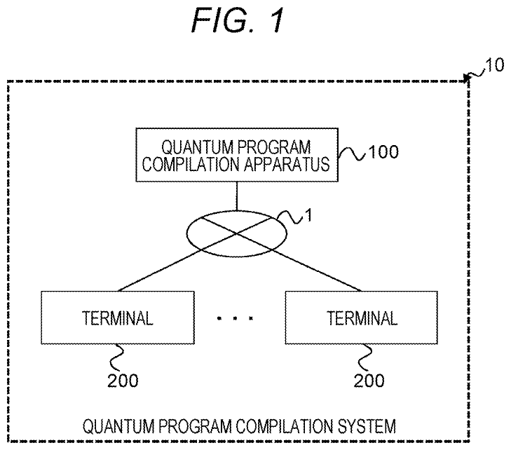

Hereinafter, embodiments of the present invention will be described in detail with reference to the drawings. FIG. 1 is a network configuration diagram including a quantum program compilation apparatus 100 according to the present embodiment. The quantum program compilation apparatus 100 illustrated in FIG. 1 is a computer that can quickly determine a movement operation procedure corresponding to the content of a quantum program.

As illustrated in FIG. 1, the quantum program compilation apparatus 100 of the present embodiment is communicatively connected to a terminal 200 via an appropriate network 1. Therefore, these may be collectively referred to as a quantum program compilation system 10.

The quantum program compilation apparatus 100 of the present embodiment can be said to be, for example, an apparatus that receives a processing request from a person who wishes to compile a quantum program and provides a compilation service of the quantum program.

On the other hand, the terminal 200 is a terminal that uploads a quantum program that is a compilation target to the quantum program compilation apparatus 100 described above and acquires a compilation result. Specifically, various information processing apparatuses such as a personal computer, a tablet terminal, and a smartphone capable of executing necessary data transmission/reception with the quantum program compilation apparatus 100 may be assumed.

### Hardware Configuration

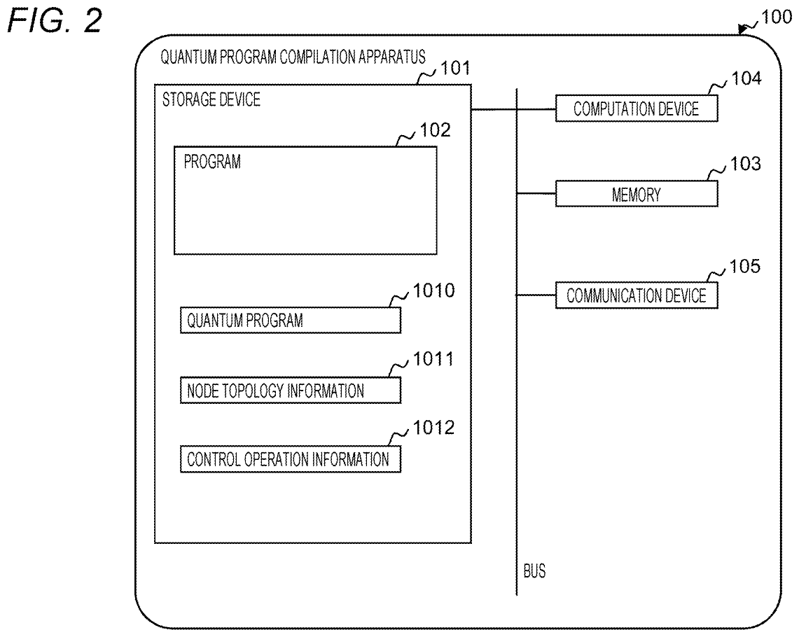

A hardware configuration of the quantum program compilation apparatus 100 of the present embodiment is as follows in FIG. 2.

That is, the quantum program compilation apparatus 100 includes a storage device 101, a memory 103, a computation device 104, and a communication device 105.

Among these, the storage device 101 includes an appropriate non-volatile storage element such as a solid state drive (SSD) or a hard disk drive.

The memory 103 includes a volatile storage element such as a RAM.

The computation device 104 is a central processing unit (CPU) that reads a program 102 stored in the storage device 101 to the memory 103 and executes the program to perform overall control of the apparatus and perform various determination, computation, and control processes.

The communication device 105 is assumed to be a network interface card or the like that is connected to the network 1 and performs communication processing with the terminal 200.

Note that, in a case where the quantum program compilation apparatus 100 is a standalone machine, it is preferable to further include an input device that accepts a key input or a voice input from a user, and an output device such as a display that displays processing data.

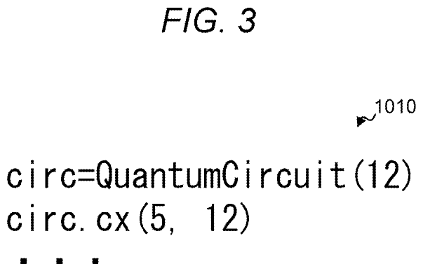

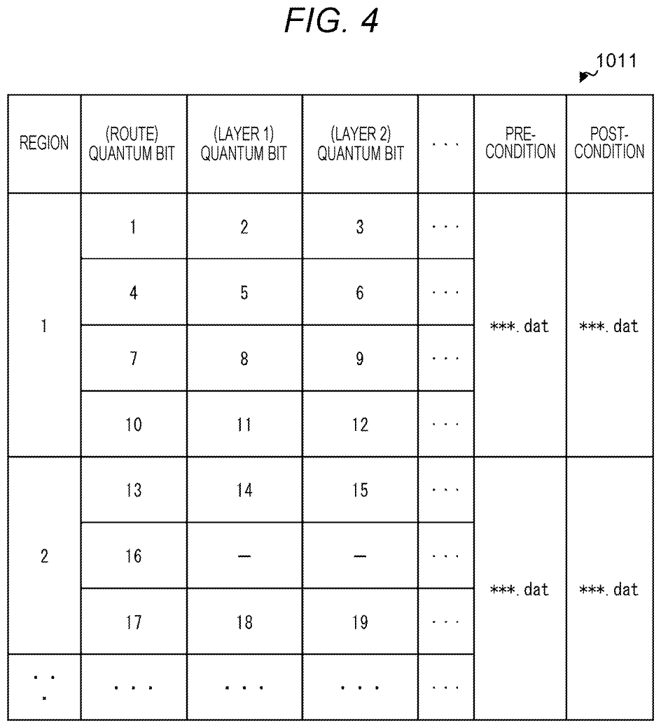

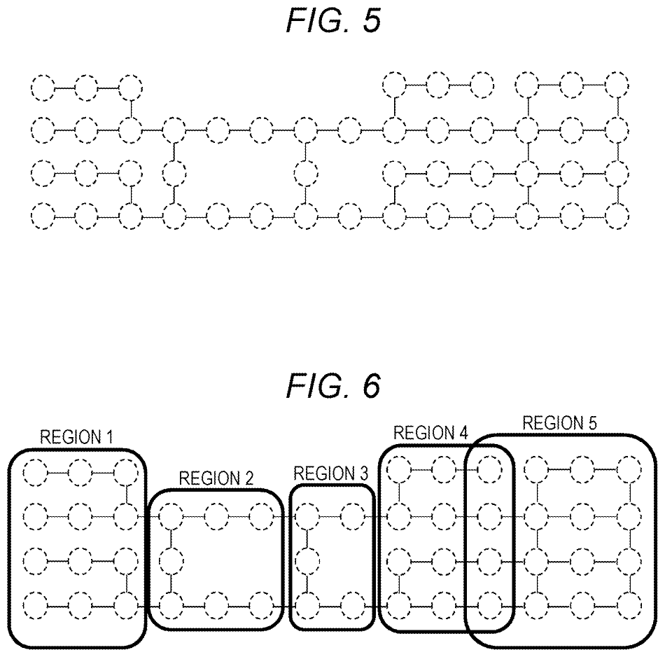

In the storage device 101, in addition to the program 102 for implementing functions necessary for the quantum program compilation apparatus of the present embodiment, at least a quantum program 1010 that is a compilation target (refer to FIG. 3), node topology information 1011 (refer to FIG. 4) and control operation information 1012 (refer to FIG. 5) necessary for a compilation process are stored. However, details of these pieces of data will be described later.

### Data Structure Example

Subsequently, various types of information used by the quantum program compilation apparatus 100 of the present embodiment will be described. FIG. 3 illustrates an example of a quantum program 1010 according to the present embodiment. As illustrated in FIG. 3, the quantum program 1010 assumed in the present embodiment is a program that performs computation of a cx gate in which a control bit is set to “5” and a target bit is set to “12” among quantum bits in a predetermined quantum circuit “12”. However, this is of course an example, and a quantum program in a form in which various quantum gates in various quantum circuits are combined may be adopted.

FIG. 4 illustrates an example of node topology information 1011 of the present embodiment, FIG. 5 illustrates an example of a quantum bit topology of the present embodiment, and FIG. 6 illustrates an example of a region configuring a quantum dot topology of the present embodiment.

The node topology information 1011 according to the present embodiment is, for example, a table in which, by using identification information of each region (refer to FIG. 6) configuring the quantum dot topology (refer to FIG. 5) as a key, a series of quantum bits included in the region is defined in a relationship between a route, that is, a starting point at which a quantum bit is present in the region, and each point at which a quantum bit is movably present toward a region adjacent thereto in the downward direction.

Of course, such a form is an example, and information defining a node topology in other forms may be used. In the node topology information 1011 of the present embodiment, a pre-condition and a post-condition are defined for each region. Specific content of the pre-condition and the post-condition will be described later.

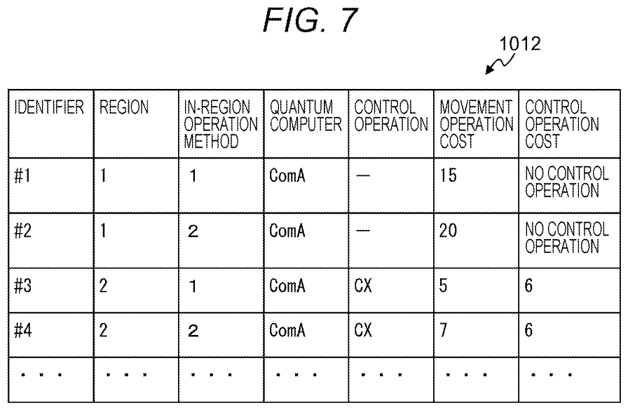

FIG. 7 illustrates an example of control operation information 1012 of the present embodiment. The control operation information 1012 in the present embodiment is, for example, information defining, for each region defined by the node topology information 1011 described above, each piece of information of an in-region operation method (described later) indicating an electron movement mode of a quantum bit that can be executed in the region, a quantum computer on which electron movement or a control operation is to be performed, an executable control operation, a movement operation cost for the quantum bit, and a control operation cost. In the information of the “control operation cost”, a value of “no control operation” is set in a case where the control operation cannot be performed in the region and the in-region operation method.

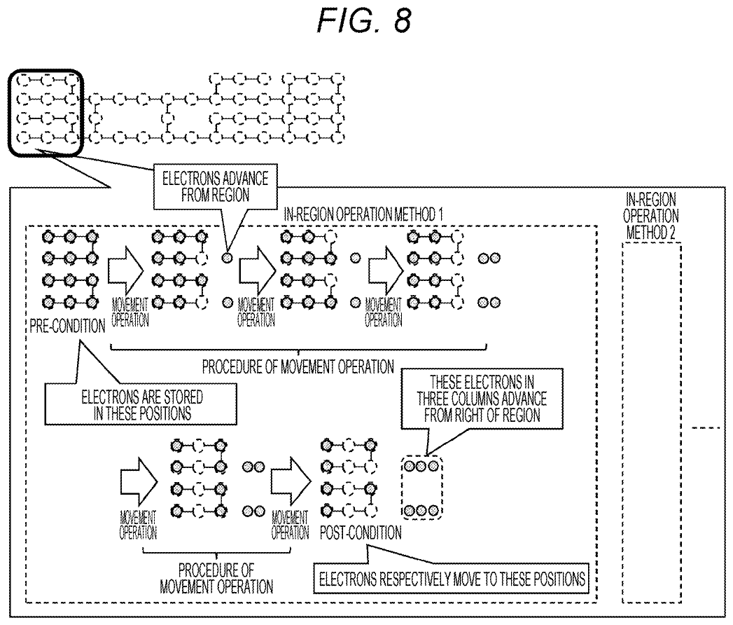

Note that FIGS. 8 to 11 illustrate an example regarding an operation of electron movement between respective quantum bits in each of region “1” and region “2”.

For example, in the example in FIG. 8, the “pre-condition” that is an existence regulation of an electron at an initial position (the left end of the region), a movement route due to the “movement operation” on each electron from the initial position, and the “post-condition” that is an existence regulation of the electron finally determined at the terminal position of the region by sequentially performing the movement operation, in a case where the “in-region operation method 1” is applied to each quantum bit of the “region 1”, are described.

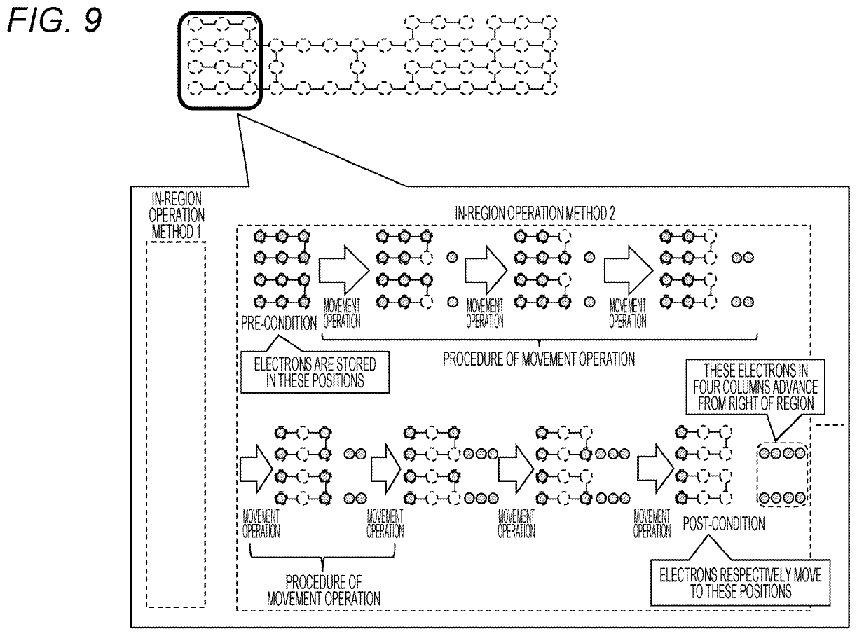

Similarly, in the example in FIG. 9, the “pre-condition” that is an existence regulation of an electron at an initial position (the left end of the region), a movement route due to the “movement operation” on each electron from the initial position, and the “post-condition” that is an existence regulation of the electron finally determined at the terminal position of the region by sequentially performing the movement operation, in a case where the “in-region operation method 2” is applied to each quantum bit of the “region 1”, are described.

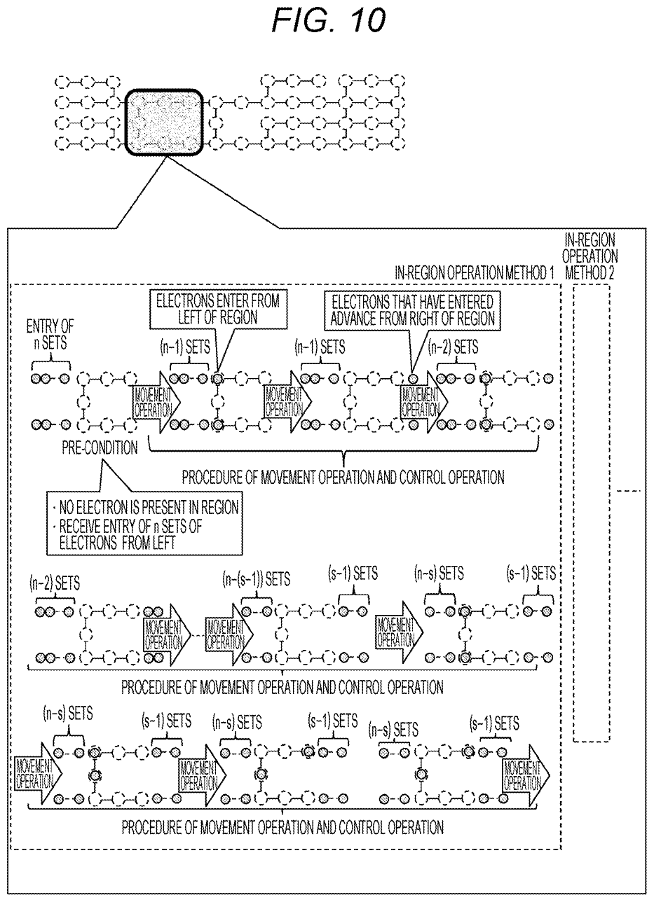

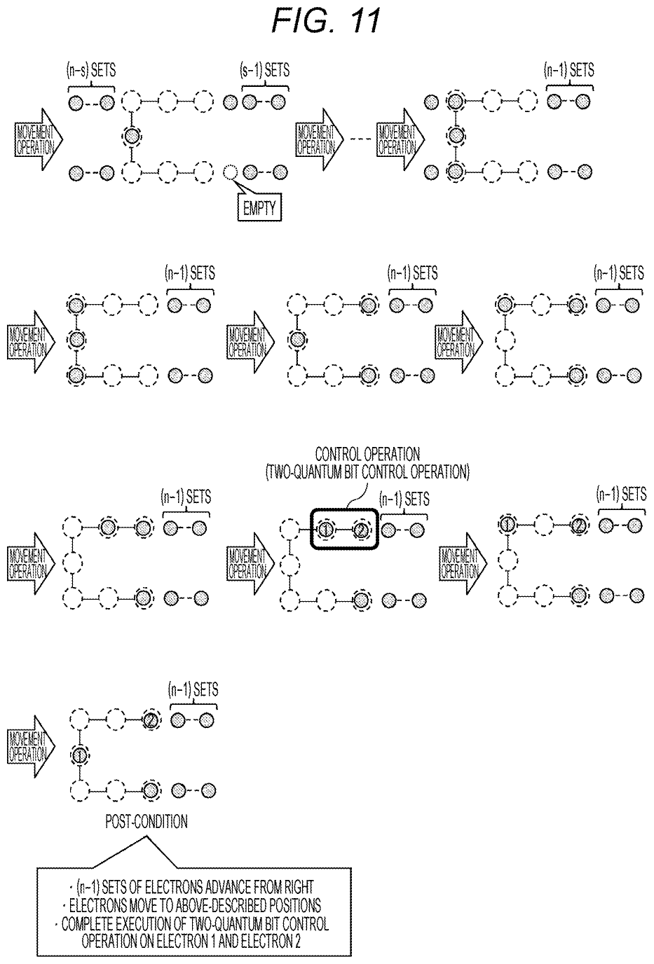

In the examples in FIGS. 10 and 11, the “pre-condition” that is an existence regulation of an electron at an initial position (the left end of the region), a movement route due to the “movement operation” on each electron from the initial position, and the “post-condition” that is an existence regulation of the electron finally determined at the terminal position of the region by sequentially performing the movement operation, in a case where the “in-region operation method 1” is applied to each quantum bit of the “region 2” downwardly adjacent to the “region 1” described above, are described.

### Flow Example

Hereinafter, an actual procedure of the quantum program compilation method according to the present embodiment will be described with reference to the drawings. Various operations corresponding to the quantum program compilation method described below are realized by a program that is read into a memory or the like and executed by the quantum program compilation apparatus 100. The program includes codes for performing various operations described below.

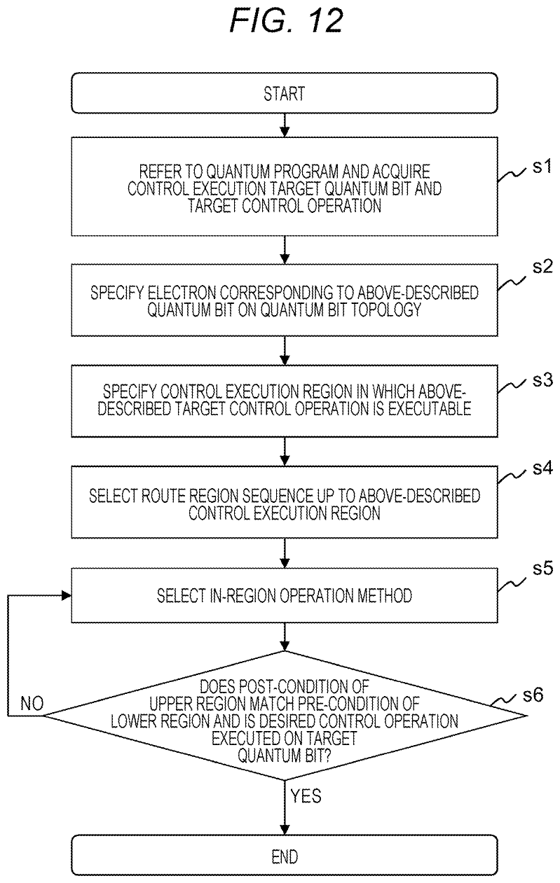

FIG. 12 is a flowchart of the quantum program compilation method according to the present embodiment. In this case, the quantum program compilation apparatus 100 refers to, for example, the quantum program 1010 (FIG. 3) provided from the terminal 200 and stored in the storage device 101, and acquires a value of each of a quantum bit that is a control execution target in the quantum program 1010 and a target control operation (s1).

In the example of the quantum program 1010 illustrated in FIG. 3, the control execution target quantum bits are “5” and “12”, and the target control operation is “cx gate”.

Subsequently, the quantum program compilation apparatus 100 refers to the node topology information 1011 and specifies electrons corresponding to the control execution target quantum bits (5, 12) acquired in s1 on a quantum dot topology indicated by the node topology information 1011 (s2). In such specifying, the quantum bits “5” and “12” of the “region 1” in the node topology information 1011 of FIG. 4 are specified.

The quantum program compilation apparatus 100 refers to the control operation information 1012 to specify a control execution region in which the target control operation (the information acquired in s1) can be executed (s3). According to the control operation information 1012 in FIG. 7, it is defined that “CX” is executable in the “region 2”, and the “region 2” is specified as the control execution region.

Subsequently, the quantum program compilation apparatus 100 selects the route region sequence up to “region 2” which is the control execution region (s4). In the present embodiment, since the “region 2” is the control execution region, the “region 1” to the “region 2” are a route region sequence. That is, in a case where the regions are serially connected, a region group in a connected state from a region serving as a movement starting point of an electron to a region that is the control execution region is the route region sequence.

On the other hand, in a form in which there is a series of regions in a plurality of systems and the control execution region finally becomes a node, a form in which the quantum program compilation apparatus 100 repeats execution of the present flow by freely selecting one of the plurality of systems by the number of systems until “YES”, that is, a desired control operation becomes executable in determination in s6 that will be described later may be assumed.

The quantum program compilation apparatus 100 selects the in-region operation method defined by the regions 1 and 2 specified so far (s5). As illustrated in FIGS. 8 to 11, the in-region operation method is for defining a method of moving electrons between quantum bits in the region.

This selection is performed by referring to the value in the “in-region operation method” field of the control operation information 1012, and selecting, for example, one in-region operation method defined for a quantum bit in which an electron that is a movement target is located. However, there may be a case where another in-region operation method defined for the quantum bit is newly selected according to a determination result in next s6.

Subsequently, the quantum program compilation apparatus 100 determines whether a post-condition of an upper region and a pre-condition of a lower region match, and a desired control operation is executed on the target quantum bit (s6). In the case of the present embodiment, the matching of the pre-condition and the post-condition is determined between the “region 1” that is an upper region and the “region 2” that is a lower region.

As the post-condition described above, it is assumed that at least one of the number of quantum bits that have advanced (toward the adjacent region 2) from the “region 1” or advancing positions thereof and stop positions of the quantum bits in the “region 1” by executing at least one of an electron movement operation and a control operation are defined. It is assumed that the quantum program compilation apparatus 100 stores information for each region in the node topology information 1011 (FIG. 4) of the storage device 101 as such a post-condition.

As the above-described pre-condition, it is assumed that at least one of the number of quantum bits entering the “region 2” (from the above-described region 1) or entry positions thereof and an initial position of the quantum bit in the “region 2” are defined. It is also assumed that the quantum program compilation apparatus 100 stores information for each region in the node topology information 1011 (FIG. 4) of the storage device 101 as such a pre-condition.

In this case, for example, the quantum program compilation apparatus 100 checks whether a post-condition of the “in-region operation method 2” (assumed to be selected in s5) in the “region 1” matches a pre-condition of the “in-region operation method 1” (assumed to be also selected in s5) in the “region 2” that is adjacent to the “region 1” and a quantum bit enters.

In a case where the post-condition of the “in-region operation method 2” in the “region 1” is, for example, a form in which a total of four sets of electrons are output from the #6 quantum bit and the #12 quantum bit, and the pre-condition of the “region 2” is, for example, a form in which, as an initial state, no electron is present in each quantum bit in the region, and a total of four sets of electrons are input to each of the #13 quantum bit and the #17 quantum bit connected to the “region 1”, there is no problem with the matching between the conditions.

However, in the “in-region operation method 2” of the “region 1”, it is assumed that the control operation is not performed on the electrons of the quantum bits “5” and “12” described above. In this case, in the determination in s6 described above, “NO”, that is, a determination result that the desired control operation is not executed on the target quantum bit is output, and the quantum program compilation apparatus 100 returns the process to s5 and selects another in-region operation method for each region.

As a result, it is assumed that the “in-region operation method 1” is selected for the “region 1” and the “in-region operation method 1” is selected for the “region 2”. Therefore, it is assumed that, as a result of executing s6 again, for example, there is no problem with the matching between the pre-condition and the post-condition as described above, and the quantum program compilation apparatus 100 is in a form of executing the control operation on the electrons of the quantum bits “5” and “12”.

In that case, in the determination in s6 described above, “YES”, that is, a determination result indicating that the desired control operation is executed on the target quantum bit is output, and the quantum program compilation apparatus 100 ends the process.

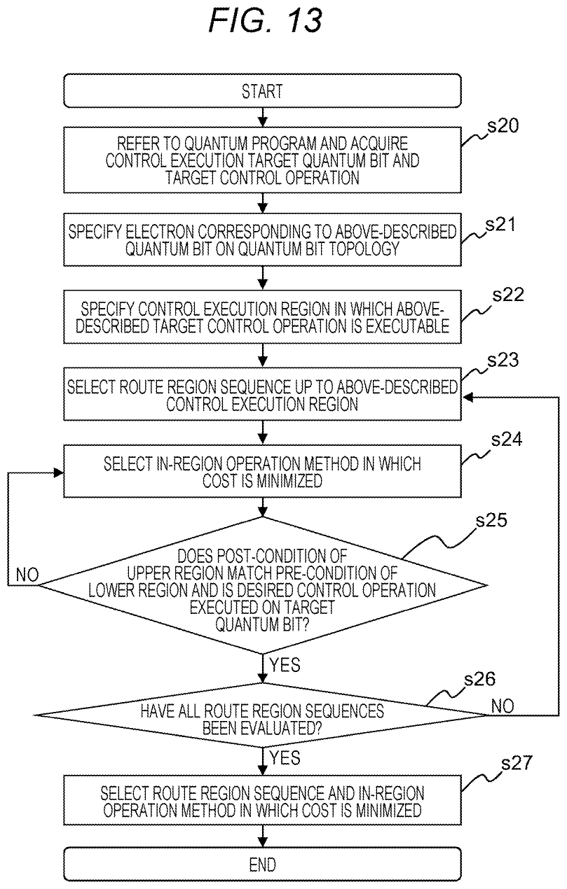

Note that, in addition to the above flow, a case where a desired control operation is executed while minimizing the cost related to an operation such as electron movement will be described on the basis of the flowchart in FIG. 13. Note that s20 to s23 in the present flow are the same as s1 to s4 in the flow in FIG. 12, and thus a description thereof will be omitted.

Here, the quantum program compilation apparatus 100 refers to the control operation information 1012 (FIG. 7) to select an in-region operation method in which cost is minimized (s24). For example, although it is possible to realize the desired control operation “CX” by any combination of (#1, #3), (#1, #4), (#2, #3), and (#2, #4) among patterns of the region and the in-region operation method, the combination pattern of the pattern (#1, #3) in which a sum of costs is minimized, that is, the combination pattern of the “in-region operation method 1” in the “region 1”, and the “in-region operation method 1” in the “region 2” is selected.

The quantum program compilation apparatus 100 determines whether the post-condition of the upper region, that is, the “region 1” and the pre-condition of the lower region, that is, the “region 2” indicated by the patterns selected in s24 match, and the desired control operation is executed on the target quantum bit (s25). This determination is similar to the process in s6 in the flow in FIG. 12, and thus the description thereof will be omitted.

As a result of the above determination, in a case where the conditions do not match or the desired control operation is not executable (s25: NO), the quantum program compilation apparatus 100 returns the process to s24, and selects a new in-region operation method.

On the other hand, as a result of the above determination, when the conditions are matched and the desired control operation can be executed (s25: YES), the quantum program compilation apparatus 100 determines whether all the route region sequences have been evaluated (s26).

As a result of the above determination, when not all the route region sequences have been evaluated yet (s26: NO), the quantum program compilation apparatus 100 returns the process to s23 and selects a new route region sequence.

On the other hand, as a result of the above determination, in a case where all the route region sequences have been evaluated (s26: YES), the quantum program compilation apparatus 100 selects a route region sequence and an in-region operation method in which the cost is minimized (s27), and ends the process.

Although the best mode and the like for carrying out the present invention have been specifically described above, the present invention is not limited thereto, and various modifications can be made without departing from the concept thereof.

When the procedures of the movement operation and the control operation are generated and evaluated through a comprehensive search, a computation amount becomes enormous. However, according to the present embodiment, the entire operation procedure is acquired by searching for a combination of patterns of the movement operation and the control operation defined in each region. Note that the pattern of the movement operation and the control operation (in-region operation method) includes “entry of electrons from the outside”, “advance of electrons to the outside”, and “electron movement operation and control operation within the inside”.

Therefore, although the search space also depends on the number of patterns, the search space is expected to be reduced as compared with the conventional comprehensive search. Therefore, the procedure of the electron movement operation and the control operation can be quickly determined. That is, a movement operation procedure corresponding to the content of the quantum program can be quickly determined.

The following content will be apparent from the description of the present specification. That is, in the quantum program compilation method of the present embodiment, the information processing apparatus may further store, in the storage device, as information of an in-region operation method defined for each partial region of the node topology, each piece of information of a pre-condition that is a premise of a quantum bit operation in the partial region, at least one of a movement operation or a control operation performed on the quantum bit under the premise, and a post-condition representing a result of at least one of the movement operation or the control operation, and generate the procedure of the movement operation and the control operation by acquiring information of a target quantum bit that is a control execution target and a target control operation on the target quantum bit from the quantum program when generating the procedure, selecting a partial region in which the target control operation is executable in the node topology as a control execution region, selecting a sequence of each partial region configuring a route from a starting point region in which the target quantum bit is present to the control execution region in the node topology as a route region sequence, and selecting the in-region operation method in each of two adjacent regions in the route region sequence such that the post-condition of the upper region and the pre-condition of the lower region match.

According to this, it is possible to efficiently specify and generate a route up to a partial region where a desired control operation (that needs to be executed by a quantum program) can be executed while achieving matching in connection between the partial regions configuring the node topology. That is, the movement operation procedure corresponding to the content of the quantum program can be determined more quickly.

In the quantum program compilation method according to the present embodiment, the information processing apparatus may store, as the pre-condition, at least one of the number of quantum bits entering the partial region or entry positions thereof and information regarding an initial position of the quantum bit in the partial region in the storage device, and execute the selection of the in-region operation method on the basis of the pre-condition including the information.

According to this, it is possible to accurately and efficiently specify and generate a route up to a partial region where a desired control operation (that needs to be executed by a quantum program) can be executed while achieving matching in connection between the partial regions configuring the node topology. That is, the movement operation procedure corresponding to the content of the quantum program can be determined more quickly.

In the quantum program compilation method according to the present embodiment, the information processing apparatus may store, in the storage device, as the post-condition, at least one of the number of quantum bits that have advanced from the partial region or an advancing position thereof and information regarding the stop position of a quantum bit in the partial region by executing at least one of the movement operation and the control operation, and execute the selection of the in-region operation method on the basis of the post-condition including the information.

According to this, it is possible to accurately and efficiently specify and generate a route up to a partial region where a desired control operation (that needs to be executed by a quantum program) can be executed while achieving matching in connection between the partial regions configuring the node topology. That is, the movement operation procedure corresponding to the content of the quantum program can be determined more quickly.

In the quantum program compilation method of the present embodiment, the information processing apparatus may store an operation cost as information of the in-region operation method in the storage device, evaluate an execution cost of the route region sequence on the basis of the operation cost, and select the route region sequence and the in-region operation method on the basis of a result of the evaluation.

According to this, the above-described movement operation procedure can be made more efficient. That is, a movement operation procedure corresponding to the content of the quantum program can be quickly determined.

In the quantum program compilation apparatus of the present embodiment, the storage device may further store, as information of an in-region operation method defined for each of the partial regions of the node topology, each piece of information of a pre-condition that is a premise of a quantum bit operation in the partial region, at least one of a movement operation or a control operation performed on the quantum bit under the premise, and a post-condition representing a result of at least one of the movement operation or the control operation, and the computation device may generate the procedure of the movement operation and the control operation by acquiring information of a target quantum bit that is a control execution target and a target control operation thereof from the quantum program when generating the procedure, selecting a partial region in which the target control operation is executable in the node topology as a control execution region, selecting a sequence of each partial region configuring a route from a starting point region where the target quantum bit is present to the control execution region in the node topology as a route region sequence, and selecting the in-region operation method in each of two adjacent regions in the route region sequence such that the post-condition of the upper region and the pre-condition of the lower region match.

In the quantum program compilation apparatus of the present embodiment, the storage device may store, as the pre-condition, at least one of the number of quantum bits entering the partial region or entry positions thereof, and information regarding an initial position of the quantum bit in the partial region, and the computation device may execute the selection of the in-region operation method on the basis of the pre-condition including the information.

In the quantum program compilation apparatus of the present embodiment, the storage device may store, as the post-condition, at least one of the number of quantum bits that have advanced from the partial region or advancing positions thereof and information regarding a stop position of the quantum bit in the partial region by executing at least one of the movement operation and the control operation, and the computation device may execute the selection of the in-region operation method on the basis of the post-condition including the information.

In the quantum program compilation apparatus of the present embodiment, the storage device may store an operation cost as information of the in-region operation method, and the computation device may evaluate an execution cost of the route region sequence on the basis of the operation cost, and select the route region sequence and the in-region operation method on the basis of a result of the evaluation.

What is claimed is:

1. A quantum program compilation method comprising causing an information processing apparatus to:
store, in a storage device, information regarding a node topology representing a connection relationship between nodes on which a quantum bit is formed and information regarding a control operation that can be performed in a predetermined region of the node topology; and
generate, for a quantum program described by a combination of control operations on the quantum bit, a procedure of a movement operation on the quantum bit according to the connection relationship as a procedure of executing the control operation of the quantum program in a predetermined region in the node topology on the basis of each piece of information of the node topology and the control operation.

2. The quantum program compilation method according to claim 1, further comprising causing the information processing apparatus to:
store, in the storage device, as information of an in-region operation method defined for each partial region of the node topology, each piece of information of a pre-condition that is a premise of a quantum bit operation in the partial region, at least one of the movement operation or the control operation performed on the quantum bit under the premise, and a post-condition representing a result of at least one of the movement operation or the control operation; and
generate the procedure of the movement operation and the control operation by acquiring information of a target quantum bit that is a control execution target and a target control operation on the target quantum bit from the quantum program when generating the procedure, selecting a partial region in which the target control operation is executable in the node topology as a control execution region, selecting a sequence of each partial region configuring a route from a starting point region in which the target quantum bit is present to the control execution region in the node topology as a route region sequence, and selecting the in-region operation method in each of two adjacent regions in the route region sequence such that the post-condition of an upper region and the pre-condition of a lower region match.

3. The quantum program compilation method according to claim 2, comprising causing the information processing apparatus to:
store, in the storage device, as the pre-condition, at least one of the number of quantum bits entering the partial region or entry positions of the quantum bits and information regarding an initial position of the quantum bit in the partial region; and execute selection of the in-region operation method on the basis of the pre-condition including the information.

4. The quantum program compilation method according to claim 2, comprising causing the information processing apparatus to:
store in the storage device, as the post-condition, at least one of the number of quantum bits that have advanced from the partial region or an advancing position of the quantum bit and information regarding a stop position of the quantum bit in the partial region by executing at least one of the movement operation and the control operation; and execute selection of the in-region operation method on the basis of the post-condition including the information.

5. The quantum program compilation method according to claim 2, comprising causing the information processing apparatus to:
store an operation cost as the information of the in-region operation method in the storage device; evaluate an execution cost of the route region sequence on the basis of the operation cost; and select the route region sequence and the in-region operation method on the basis of a result of the evaluation.

6. A quantum program compilation apparatus comprising:
a storage device that stores information regarding a node topology representing a connection relationship between nodes on which a quantum bit is formed and information regarding a control operation that can be performed in a predetermined region of the node topology; and
a computation device that generates, for a quantum program described by a combination of control operations on the quantum bit, a procedure of a movement operation on the quantum bit according to the connection relationship as a procedure of executing the control operation of the quantum program in a predetermined region in the node topology on the basis of each piece of information of the node topology and the control operation.

7. The quantum program compilation apparatus according to claim 6, wherein
the storage device further stores, as information of an in-region operation method defined for each partial region of the node topology, each piece of information of a pre-condition that is a premise of a quantum bit operation in the partial region, at least one of the movement operation or the control operation performed on the quantum bit under the premise, and a post-condition representing a result of at least one of the movement operation or the control operation, and
the computation device generates the procedure of the movement operation and the control operation by acquiring information of a target quantum bit that is a control execution target and a target control operation on the target quantum bit from the quantum program when generating the procedure, selecting a partial region in which the target control operation is executable in the node topology as a control execution region, selecting a sequence of each partial region configuring a route from a starting point region in which the target quantum bit is present to the control execution region in the node topology as a route region sequence, and selecting the in-region operation method in each of two adjacent regions in the route region sequence such that the post-condition of an upper region and the pre-condition of a lower region match.

8. The quantum program compilation apparatus according to claim 7, wherein
the storage device stores, as the pre-condition, at least one of the number of quantum bits entering the partial region or entry positions of the quantum bits and information regarding an initial position of the quantum bit in the partial region, and
the computation device executes selection of the in-region operation method on the basis of the pre-condition including the information.

9. The quantum program compilation apparatus according to claim 7, wherein
the storage device stores, as the post-condition, at least one of the number of quantum bits that have advanced from the partial region or an advancing position of the quantum bit and information regarding a stop position of the quantum bit in the partial region by executing at least one of the movement operation and the control operation, and
the computation device executes selection of the in-region operation method on the basis of the post-condition including the information.

10. The quantum program compilation apparatus according to claim 7, wherein
the storage device stores an operation cost as the information of the in-region operation method, and
the computation device evaluates an execution cost of the route region sequence on the basis of the operation cost, and selects the route region sequence and the in-region operation method on the basis of a result of the evaluation.
